(19) United States
(12) Patent Application Publication
(10) Pub. No.: US 2009/0084634 A1
(43) Pub. Date: Apr. 2, 2009

(54) VERSATILE SPROCKET SHEAVE ASSEMBLY

(76) Inventors: Chris M. Queen, Christiansburg, VA (US); Jeffrey J. Farrenkopf, Christiansburg, VA (US)

Correspondence Address: MORGAN & FINNEGAN, L.L.P., 3 WORLD FINANCIAL CENTER, NEW YORK, NY, 10281-2101, US

(21) Appl. No.: 11/862,660

(22) Filed: Sep. 27, 2007

(51) Int. Cl. B66B 11/08

(52) U.S. Cl. 187/254

(57) ABSTRACT

An elevator system may include a motor having a common shaft which is suitable to engage any one of a plurality of interchangeable drive component assemblies, and a drive component assembly selected from the plurality of different interchangeable drive assemblies and engaged to the common shaft. The plurality of interchangeable drive component assemblies can be a sheave assembly or a sprocket assembly. The motor can be a direct drive motor, e.g., a permanent magnet (PM) brushless motor or a synchronous motor. The plurality of interchangeable drive component assemblies may also include one or more components which are interchangeable between the assemblies, e.g., a manual lowering device (MLD) or a spacer or a hub. The plurality of interchangeable drive component assemblies may each be assembled from a set of pre-configured assembly components configured for use with the common shaft.

### FIELD OF THE INVENTION

The present invention relates to a method, system and apparatus related to an elevator system or machine and assembly thereof, and more particularly to an interchangeable drive component assembly for use in elevator system or machine.

### BACKGROUND

Today's home elevator market is populated with machines with geared system and chain sprocket assemblies. The industry desires to switch to direct drive systems where the gearbox is not required. This is mainly driven by the need to improve ride quality and reduce system audible noise and vibration. There are two methods to couple the car load to the machine with the direct drive approach. One method is to use a roped system with a sheave, and the second method is to continue to use the chain sprocket assembly mounted to the direct drive machine. These two approaches however create a need for two different elevator machines in order to handle the two different mechanical configurations.

### SUMMARY

In accordance with one embodiment, an elevator system includes a motor having a common shaft which is suitable to engage any one of a plurality of interchangeable drive component assemblies, and a drive component assembly selected from the plurality of different interchangeable drive assemblies and engaged to the common shaft. The plurality of interchangeable drive component assemblies can be a sheave assembly or a sprocket assembly. The motor can be a direct drive motor, e.g., a permanent magnet (PM) brushless motor or a synchronous motor. The plurality of interchangeable drive component assemblies may also include one or more components which are interchangeable between the assemblies, e.g., a manual lowering device (MLD) or a spacer or a hub. The plurality of interchangeable drive component assemblies may each be assembled from a set of pre-configured assembly components configured for use with the common shaft.

In accordance with a further embodiment, a method of assembling an elevator system which involves providing a motor having a common shaft configured to engage any one of a plurality of different interchangeable drive component assemblies; selecting a drive component assembly from the plurality of different interchangeable drive component assemblies; and engaging and securing the selected drive component assembly to the common shaft. The plurality of different interchangeable drive component assemblies may include a sprocket assembly or a sheave assembly.

The method of assembly may further involve removing an already engaged drive component assembly, prior to engaging and securing the selected drive assembly to the common shaft, the removed drive component assembly being a different drive component configuration than the selected drive component assembly. The removed drive component assembly can be one of a sprocket assembly and a sheave assembly, and the selected drive component assembly can be the other of the sprocket and the sheave assembly.

The method of assembly may further involve assembling the selected drive component assembly using a set of pre-configured assembly components configured for use with the common shaft. The set may include one or more pre-configured components which are interchangeable between different drive component assemblies of the plurality of different interchangeable drive component assemblies.

### BRIEF DESCRIPTION OF THE DRAWINGS

FIG. 1 illustrates a simplified overview of an exemplary elevator system in accordance with an embodiment;

FIGS. 2-4 illustrate various perspective views of an exemplary interchangeable drive component assembly for an elevator system in accordance with a embodiment;

FIGS. 5-7 illustrate various perspective views of an exemplary interchangeable drive component assembly for an elevator system in accordance with a further embodiment;

FIG. 8 illustrates a flow diagram of an exemplary process by which an elevator system is assembled in accordance with an embodiment; and

FIG. 9 illustrates a flow diagram of an exemplary process by which an elevator system is assembled in accordance with a further embodiment.

### DETAILED DESCRIPTION OF THE VARIOUS EMBODIMENTS

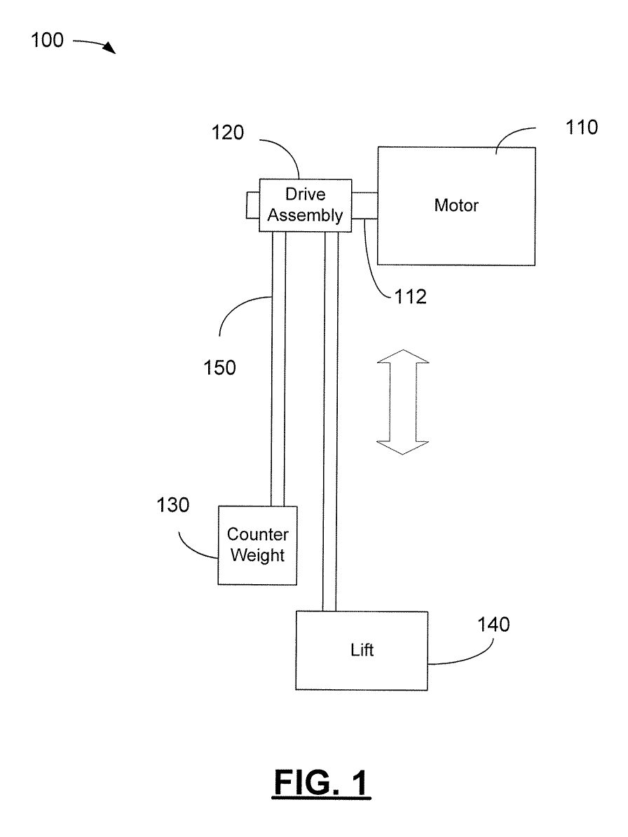

FIG. 1 illustrates a simplified overview of an exemplary elevator system 100 in accordance with an embodiment. As shown in FIG. 1, the elevator system 100 may include a motor 110 with a common shaft 120 (or with a common dimension or configuration), a drive component assembly 120 engaged to the shaft 112, a pulley system 150, a lift 140 and a counter weight 130. The pulley system 150 may be a rope or chain-based or -driven system. In operation, the motor 110 can be operated to cause the drive component assembly 120 thereon to drive the pulley system 150 to move the lift 140 in a desired direction (e.g., up or down), such as shown by the arrow.

To facilitate assembly, upgrade and/or operation of elevator systems, the elevator system 150 is configured with a motor having a common shaft which is suitable to engage any one of a plurality of interchangeable drive component assemblies, and a drive component assembly selected from the plurality of different interchangeable drive assemblies and engaged to the common shaft.

By way of example, the elevator system 100 may employ motor 110, such as a direct drive brushless or synchronous motor without a gearbox with a mechanical output configuration and electrical winding that is able to mount different drive component assemblies, e.g., either a sheave assembly for use with a rope pulley system or a chain sprocket assembly for use with a chain pulley system. This can be accomplished by using a common shaft (or output shaft) 112, for example, in a cantilevered load configuration while utilizing both common and option specific spacers and clamping means to attach the drive component assemblies, e.g., either the sheave or the sprocket to shaft. The elevator system 100 or the drive component assembly 120 may also include an emergency manual lowering device (MLD) which can be incorporated onto the common shaft 112 and work with both exemplary configurations. In these examples, the elevator system 100 may use for example a roped 2:1 sheave to shaft assembly, or a 1:1 chain sprocket assembly. Further, one or more components of the drive component assembly may be formed into a unitary component, or may be interchangeable between different drive component assemblies, or may be preconfigured in size and/or dimension to facilitate assembly thereof onto a common shaft.

The assembly of the elevator system 100 can be easily accomplished using a simple shaft and keyway and sliding components over the common shaft with a clearance fit, although many other fit methods can be employed to accomplish the assembly. An easy, exemplary clamping method is to use one or more bolts to secure the clamping device in the axial direction of the shaft although a variety of clamping means can be employed, such as adhesive bonds, nut with threaded shaft, tapered locking hub inserts, taper shaft, pins, setscrews, etc.

Accordingly, in accordance with various exemplary embodiments, the elevator system 100 as discussed herein can provide various benefits and/or advantages, such as for example minimizing the number of machine/shaft variations to accomplish this, which allows elevator system integrators to choose, at point of installation, which configuration they need without having to order a special machine. For example, the MLD can be mounted on the motor shaft first up against a shoulder (e.g., shoulder, retaining ring or spacer) on the shaft. The MLD can have a hub extension acting as a spacer or a spacer can be provided with a single plane MLD. The sprocket or the sheave can then be mounted to the shaft. A clamping device can then be mounted to the shaft up against the sheave or the sprocket. The clamping device can be secured through various means. The elevator machine is now ready for the customer application.

Furthermore, the elevator system 100 provides an approach which facilitates upgrade or modification to a different drive component assembly. That is, the elevator system as discussed herein provides a common elevator machine shaft and set of drive components which is easily exchanged at point of manufacture or other location saving time and costs. For example, a sheave assembly can be changed to a sprocket assembly without requiring a complete redesign (e.g., a special order machine) and replacement of the motor/drive component assembly configuration. In this situation, the different assemblies can simply be exchanged on the same motor. Further, the pre-sizing or configuring of assembly components (e.g., drive component, spacers, hubs, MLD, etc.) with respect to a common shaft allows for subsequent ease and flexibility in assembly of the motor/drive component assembly of the elevator system 100. By using a set of common or pre-configured (or pre-sized) component parts with respect to a common shaft, an elevator system integrator may assemble components in any desired order onto the common shaft, assemble different components as desired (e.g., MLD if desired) onto the common shaft, and assemble different drive components (e.g., sheave, or sprocket, etc.) as desired.

Further, the elevator system as described herein can facilitate easy upgrade in the future if a new component (e.g., other safety mechanism such as the MLD) is to be added to the drive component assembly. For example, the spacers or hubs can be added with respect to a common shaft as space or place holders for upgrade of future components.

These and other exemplary embodiments of an elevator system (or machine) and drive component assemblies are described below in greater detail with reference to the drawings.

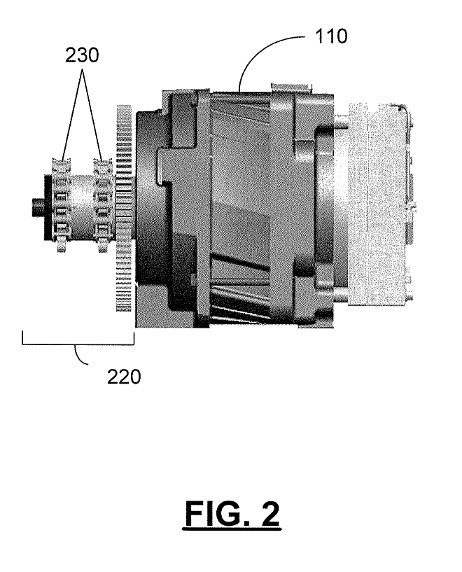

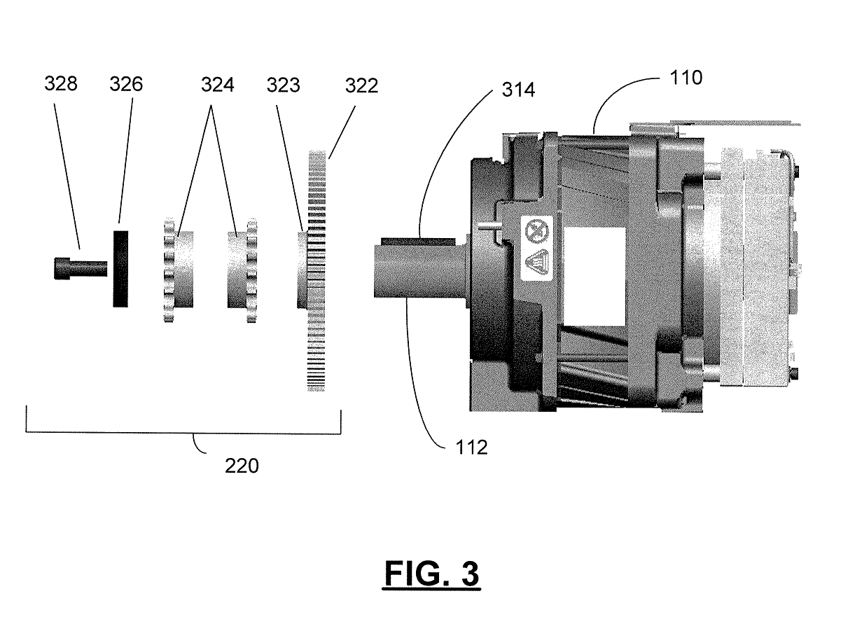

FIGS. 2-4 illustrate various perspective views of an exemplary interchangeable drive component assembly for an elevator system in accordance with a embodiment. As shown, in this exemplary embodiment, the interchangeable drive component assembly is a sprocket-type (or chain-sprocket) assembly 220 which is used with a chain(s) 230. The drive component assembly 220 is slidable onto the common shaft 112 which is shown in this example with a key or tongue 314 to prevent rotational movement on the common shaft 112 when engaged thereon. For example, motor 110 may be a direct drive motor with a simple keyed shaft.

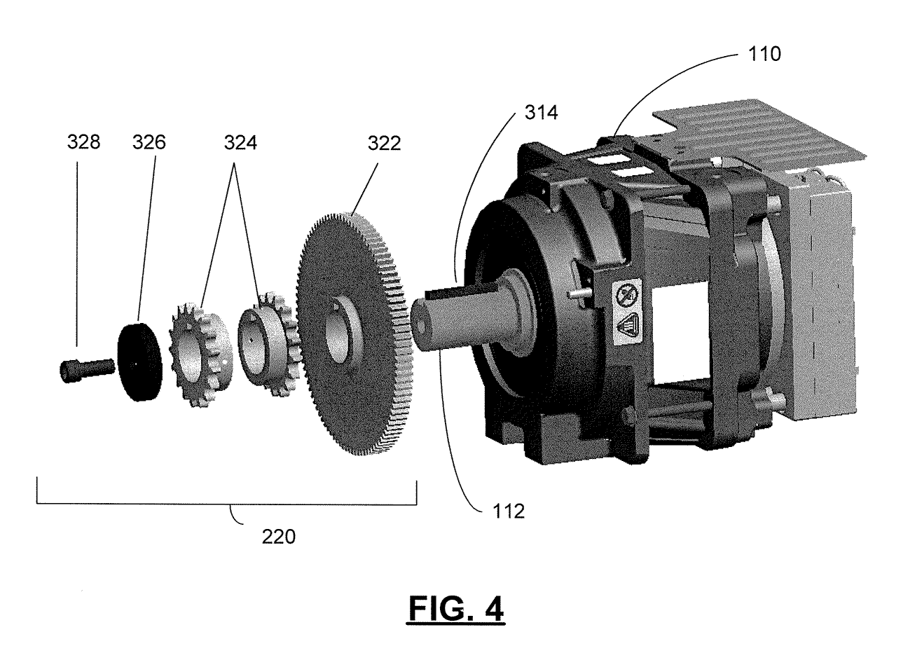

The drive component assembly 220 in this example includes a manual lowering device (MLD) or gear 322 which has a hub or spacer 323 extending therefrom, sprocket(s) 324 to receive chain(s), and clamp or clamping device 326 which includes a bolt(s) 328 for securing at least axially the components of the drive component assembly 220 on the common shaft 112. As shown in FIG. 4, the bolt(s) 328 can be engaged and secured into a corresponding hole in the common shaft 112

Although the common shaft 112 employs a key or tongue/groove configuration with respect to the components of assembly 220, other configurations or shapes for the shaft and components of assembly 220 or securing approaches (e.g., adhesives, etc.) can be used to prevent rotational movement of the components of assembly 220 on the common shaft 112 when engaged thereon. The order and number of the components of assembly 220 on the motor shaft may also be changed and other components may be added or removed from assembly 220 to customize the drive component assembly for specific elevator applications or requirements. For example, the number of sprockets or other assembly components can be increased or decreased. Further, various or any number of components of the assembly may be formed into a unitary component (e.g., MLD with spacer or hub can be formed together with the sprocket(s), or the two sprockets can be formed as one component, or the whole assembly can be formed together as a unit, etc.).

Other approaches for engaging the assembly components onto the common shaft may be employed, e.g., shrink-fitting the components onto the common shaft, etc. Other clamping means may also be used to secure the drive component assembly onto the common shaft, such as adhesive bonds, nut with threaded shaft, tapered locking hub inserts, taper shaft, pins, setscrews, etc.

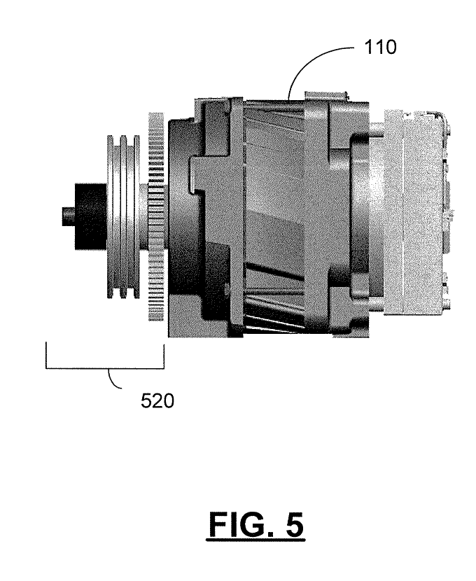

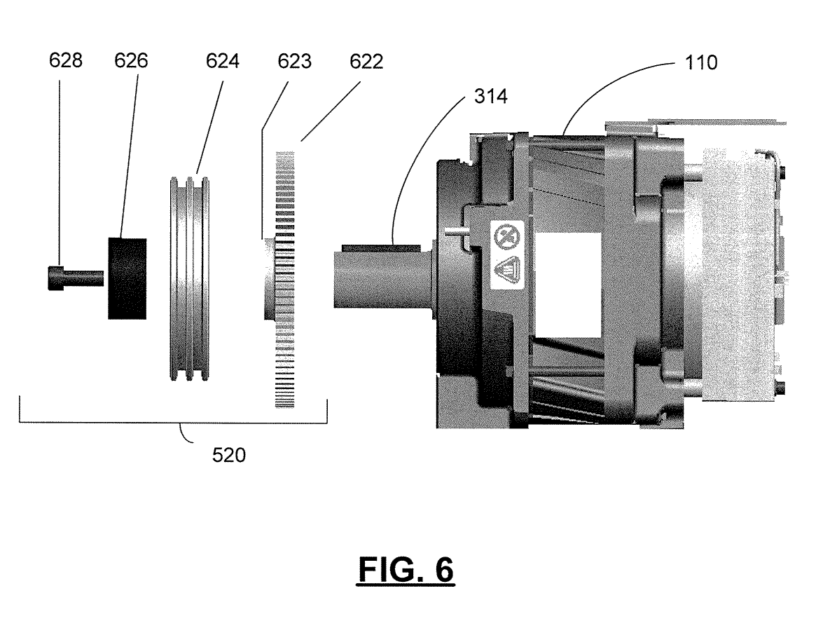

FIGS. 5-7 illustrate various perspective views of an exemplary interchangeable drive component assembly for an elevator system in accordance with a further embodiment. As shown, in this exemplary embodiment, the interchangeable drive component assembly is a rope-type assembly 520 which is used with a rope(s) such as, e.g. metal or steel or composite rope(s), etc. The drive component assembly 520 is slidable onto the common shaft 112 which is shown in this example with a key or tongue 314 to prevent rotational movement on the common shaft 112 when engaged thereon. For example, motor 110 may be a direct drive motor with a simple keyed shaft.

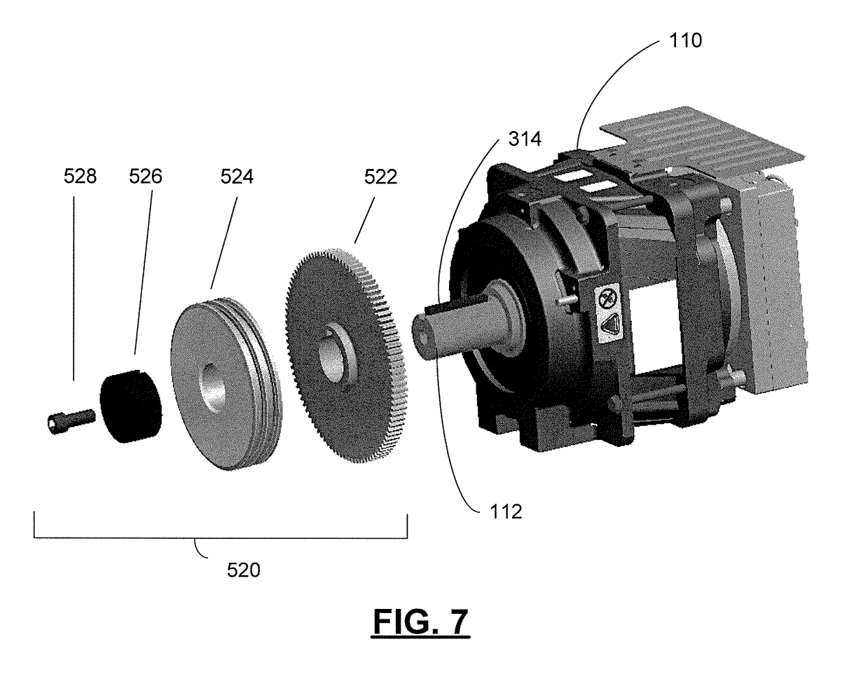

The drive component assembly 520 in this example includes a manual lowering device (MLD) or gear 622 which has a hub or spacer 623 extending therefrom, sheave(s) 624 to receive rope(s), and clamp or clamping device 626 which includes a bolt(s) 628 for securing at least axially the components of the drive component assembly 520 on the common shaft 112. As shown in FIG. 7, the bolt(s) 628 can be engaged and secured into a corresponding hole in the common shaft 112

Although the common shaft 112 employs a key or tongue/groove configuration with respect to the components of assembly 520, other configurations or shapes for the shaft and components of assembly 520 or securing approaches (e.g., adhesives, etc.) can be used to prevent rotational movement of the components of assembly 520 on the common shaft 112 when engaged thereon. The order and number of the components of assembly 520 on the motor shaft may also be changed and other components may be added or removed from assembly 520 to customize the drive component assembly for specific elevator applications and requirements. For example, the number of sheaves or other assembly components can be increased or decreased. Further, various or any number of the components of the assembly may be formed into a unitary component (e.g., MLD with spacer or hub can be formed together with the sheave(s), or the whole assembly can be formed together as a unit, etc.).

Other approaches for engaging the assembly components onto the common shaft may be employed, e.g., shrink-fitting the components onto the common shaft, etc. Other clamping means may also be used to secure the drive component assembly onto the common shaft, such as adhesive bonds, nut with threaded shaft, tapered locking hub inserts, taper shaft, pins, setscrews, etc.

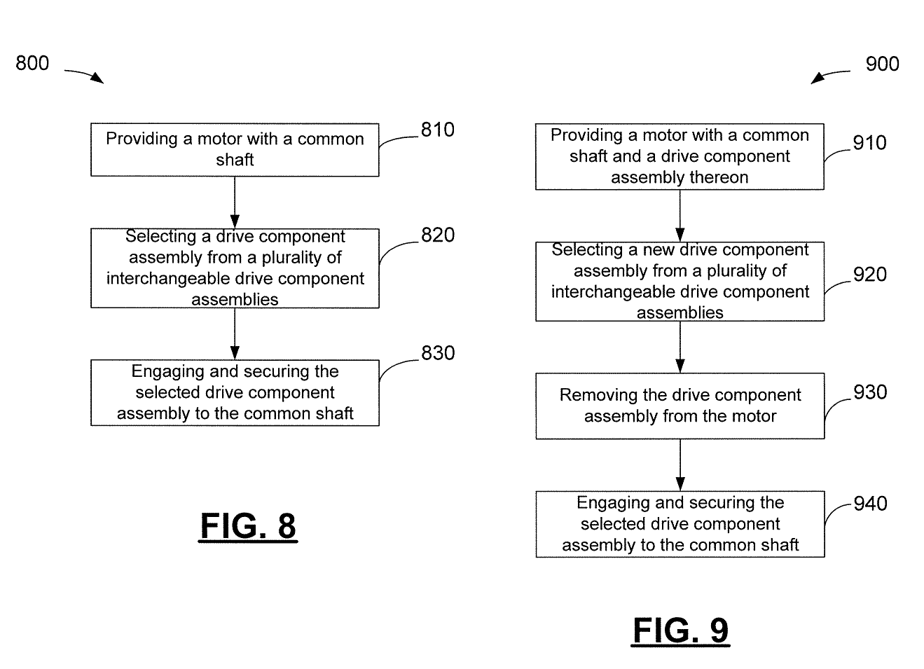

FIG. 8 illustrates a flow diagram of an exemplary process 800 by which an elevator system is assembled in accordance with an embodiment. The process 800 involves providing a motor with a common shaft at step 810. At step 820, a drive component assembly from a plurality of interchangeable drive component assemblies is selected. At step 830, the selected drive component assembly is engaged and secured to the common shaft of the motor.

The selecting or engaging operations may involve assembling of the drive component assembly. This may involve selecting components from a set of pre-configured (or pre-sized) components configured with respect to the common shaft or its common dimension. In this way, a customized drive component assembly may be configured or updated or changed and assembled in an easy and efficient manner.

FIG. 9 illustrates a flow diagram of an exemplary process by which an elevator system is assembled in accordance with a further embodiment. The process 900 involves providing a motor with a common shaft and a drive component assembly thereon at step 910. At step 920, a drive component assembly from a plurality of interchangeable drive component assemblies is selected. At step 930, the drive component assembly is removed from the motor. At step 940, the selected drive component assembly is engaged and secured to the common shaft of the motor.

The selecting or engaging operations may involve assembling of the drive component assembly. This may involve selecting components from a set of pre-configured (or pre-sized) components configured with respect to the common shaft or its common dimension. Further, as some of the components may be interchangeable, the new selected drive component assembly may reuse components from the removed assembly. In this way, a customized drive component assembly may be configured or updated or changed and assembled in an easy and efficient manner.

Although the above FIGS. 8 and 9 describe exemplary processes for assembling an elevator system, the assembling processes are not limited to the particular steps, order of steps or implementation described in these examples or particular types of components. For example, as discussed above, the motor can be a direct drive motor or any motor with a common shaft or a motor shaft with a common dimension suitable for use with elevators. The drive component assembly can be a sprocket (or gear) assembly such as used with a chain or the like or a sheave assembly such as used with a rope or the like or other drive component assemblies for other types of pulley systems and configurable to be interchangeable with other assemblies for a motor used with elevators. As further noted above, the plurality of interchangeable drive component assemblies may employ one or more sub-components which are interchangeable between the different assemblies, such as a manual lowering device, spacer, hub and so forth.

Furthermore, the providing, selecting and engaging steps or operations of processes 800 and 900 may be performed at the same or different locations, e.g., at the factory or installation site, etc.

While various embodiments of the present invention have been described above, it should be understood that they have been presented by way of example only, and not in limitation. Accordingly, it will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents. Thus, other types of motors, drive components, pulley systems, lifts are within the scope of the present invention.

What is claimed is:

1. An elevator system, comprising:
a motor having a common shaft which is suitable to engage any one of a plurality of interchangeable drive component assemblies;
a drive component assembly selected from the plurality of different interchangeable drive assemblies and engaged to the common shaft.

2. The elevator system according to claim 1, wherein the plurality of interchangeable drive component assemblies comprises a sheave assembly or a sprocket assembly.

3. The elevator system according to claim 1, wherein the motor is a direct drive motor.

4. The elevator system according to claim 1, wherein one of the plurality of drive component assemblies comprises a drive component and a manual lowering device.

5. The elevator system according to claim 4, wherein the drive component comprises a sheave or a sprocket.

6. The elevator system according to claim 4, wherein the manual lowering device and the drive component are formed as a unitary component.

7. The elevator system according to claim 4, where the one of the plurality of drive component assemblies further comprises one or more spacers or hubs.

8. The elevator system according to claim 1, wherein the common shaft is configured to prevent the drive component assembly engaged thereon from rotating on the common shaft.

9. The elevator system according to claim 1, further comprising a securing device for securing the assembly to the common shaft.

10. The elevator system according to claim 1, further comprises:
a lift; and
a pulley system connected to the lift and operable by the motor through the drive component assembly to move the lift.

11. The elevator system according to claim 1, wherein the plurality of interchangeable drive component assemblies include one or more components which are interchangeable between the assemblies.

12. The elevator system according to claim 11, wherein the one or more interchangeable components comprises a manual lowering device or a spacer or a hub.

13. The elevator system according to claim 1, wherein the plurality of interchangeable drive component assemblies are each assembled from a set of pre-configured assembly components configured for use with the common shaft.

14. A method of assembly an elevator system comprising:
providing a motor having a common shaft configured to engage any one of a plurality of different interchangeable drive component assemblies;
selecting a drive component assembly from the plurality of different interchangeable drive component assemblies; and
engaging and securing the selected drive component assembly to the common shaft.

15. The method according to claim 14, wherein the plurality of different interchangeable drive component assemblies include a sprocket assembly or a sheave assembly.

16. The method according to claim 14, wherein the common shaft of the motor already has engaged thereon a drive component assembly, the method further comprising:
removing the already engaged drive component assembly, prior to engaging and securing the selected drive assembly to the common shaft, the removed drive component assembly being a different drive component configuration than the selected drive component assembly.

17. The method according to claim 16, wherein the removed drive component assembly is one of a sprocket assembly and a sheave assembly, and the selected drive component assembly is the other of the sprocket and the sheave assembly.

18. The method according to claim 14, further comprising:
assembling the selected drive component assembly using a set of pre-configured assembly components configured for use with the common shaft.

19. The method according to claim 18, wherein the set includes one or more pre-configured components which are interchangeable between different drive component assemblies of the plurality of different interchangeable drive component assemblies.

20. The method according to claim 18, wherein the set includes two or more different drive components to select from.
